(19) United States
(12) Patent Application Publication
(10) Pub. No.: US 2011/0197480 A1
(43) Pub. Date: Aug. 18, 2011

(54) Wire frame for attaching a free swinging sign panel made from corrugated plastic, paper card stock or similar materials

(76) Inventor: John R. Nasiatka, Northbrook, IL (US)

(21) Appl. No.: 12/930,773

(22) Filed: Jan. 18, 2011

Related U.S. Application Data
(60) Provisional application No. 61/337,815, filed on Feb. 12, 2010.

(51) Int. Cl. G09F 13/16; G09F 15/00; G09F 7/12

(52) U.S. Cl. 40/582; 40/606.14; 40/594

(57) ABSTRACT

An outdoor sign having a wire supporting frame for a sign panel, the sign panel being attached to the supporting frame with cable ties in a manner to allow free movement of the sign panel within the supporting frame.

### BACKGROUND OF THE INVENTION

1. Field of the Invention

This invention relates to an inexpensive temporary outdoor signage as typically used to promote election candidates, yard sales, etc.

2. Description of Prior Art

The two (2) most popular types of inexpensive, temporary signs are manufactured from 1) corrugated plastic material, or 2) weather resistant paper card stock material. 1) The corrugated plastic material is typically imprinted with the desired message on both sides. In using a sign manufactured from 1) corrugated plastic material, the sign is typically held in place at the desired location with an H shaped wire support. The (2) lower legs of the H wire support are pressed into the ground. The two (2) remaining exposed legs are then slid into the corrugated opening of the sign material. This type of construction/assembly has the inherent problem that after the H wire form is pressed into the ground, the two (2) exposed legs are no longer straight or parallel to each other and a great deal of difficulty is then experienced when trying to assemble the corrugated plastic sign on to the exposed legs. This frequently results in a severely damaged sign. Signs manufactured from 2) weather resistant paper card stock material. The material is imprinted on one side of the material with the desired message. It is then folded over, in equal segments, 180°. The folded edge section now forms the top horizontal edge of the sign. The two (2) sides are sealed with an adhesive or stapled so that the printed message is visible from both sides. In using a sign manufactured in this manner, the sign is typically held in place at the desired location by sliding it over an inverted U shaped wire support. The two (2) lower legs of the inverted U shaped wire support are pressed part way into the ground. The remaining exposed portion then supports the body of the sign.

Signs manufactured from either type of material and assembly method are subjected to a common problem of wind damage. In a strong wind, the large rigid face of the sign will cause the supporting wire frame to bend and/or pull the sign and its wire support out of the ground. Seldom, if ever, is the sign replaced due to damage and, for political/election signs, the volunteer workers originally placing the signs do not want to go back a second time to repair or replace the sign. The signs are then picked up by municipal workers and go in the garbage.

### SUMMARY OF THE INVENTION

The wire frame support in this invention is a simple inverted U shape wire frame. The width of the frame being several inches wider than the width of the sign, with the sign panel being hung from the horizontal portion of the frame, while being centrally positioned between the vertical legs of the wire frame by two (2) V shaped formations in the horizontal section of the frame where the attachment of the sign panel is made. Attaching the sign panel to the wire frame is completed by using two (2) commercially available plastic cable ties. The sign panel remains loose but secure and centered within the wire frame, allowing the sign panel to lift upwardly when subjected to a wind force. The central positioning of the sign panel within the frame and its attachment to the frame will be well understood when taken in conjunction with the three (3) drawings. Additionally, movement of the sign in a light wind will attract more attention than a stationary sign and, may be further enhanced by using reflective materials embedded in the body of the sign.

### DESCRIPTION OF THE DRAWINGS

FIG. 1 An elevational view of the sign panel and wire frame assembly, showing the sign panel 13 attached to the frame 10 with the plastic cable ties 11 passing through apertures 12 in the sign panel 13 corresponding alignment with the V formations 14 in the horizontal portion of the frame 10, thereby positioning the sign panel centrally between the two (2) legs of the wire frame 10 for unrestricted upward movements when the sign panel is subjected to a wind force. The sign panel would return to a normal hanging position by its own weight.

FIG. 2 An enlarged view of the corner of the wire frame 10 showing the V formation 14 in the horizontal portion of the wire frame 10 with the plastic cable tie passing through the aperture 12 in the sign panel.

FIG. 3 An enlarged section BB view passing through the horizontal portion of the wire frame 10 showing the plastic cable tie 11 passing through the aperture 12 the sign panel 13 and resting in the lower portion of the V formation 14 of the wire frame.

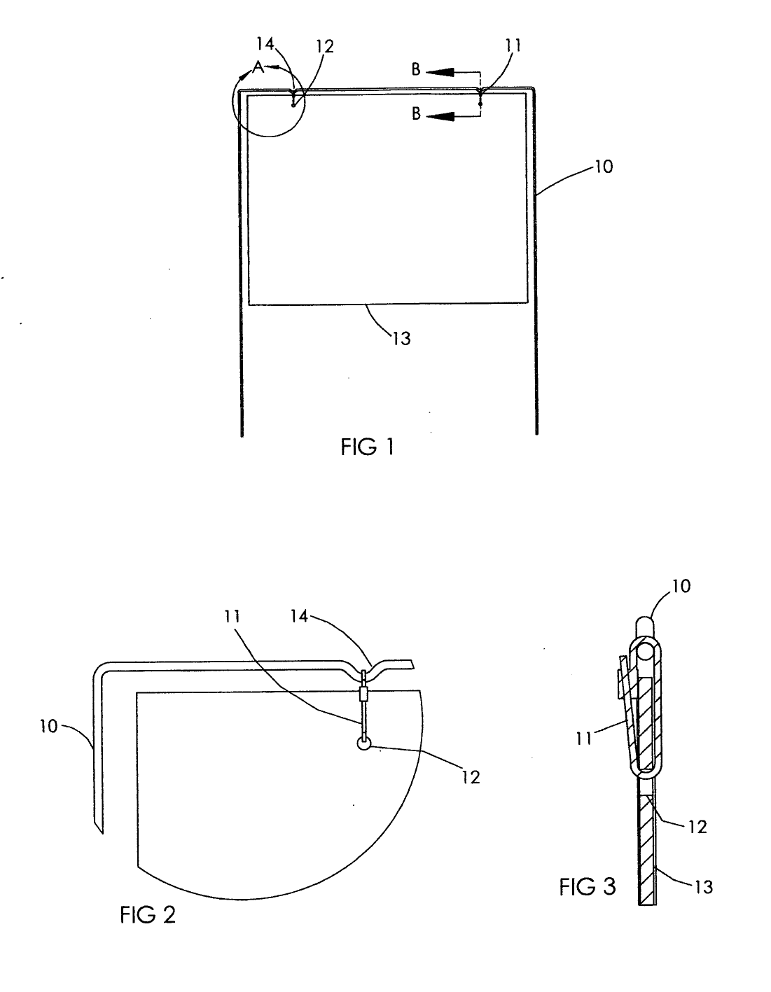

The sign panel referenced in all figures may be constructed of any common materials typically used for this purpose such as corrugated plastic, weather resistant paper, PVC sheet plastic or metal.

Obviously, many modifications and variations of the present invention are possible in light of the above teachings. Therefore, it is to be understood that within the scope of this appended claims, the invention may be appreciated otherwise than as specifically describe above.

What is claimed and desired to be secured by a Letters Patent of the United States is:

1. An outdoor sign comprising of a metal wire support frame and a sign panel fabricated from commercially available material such as paper card stock, paper or plastic corrugated stock or similar rigid or semi rigid materials. The support frame having 2 or more V shaped formations in the header with the supporting legs being spaced proportionally wider apart than the body of the sign panel being supported by the frame so as to allow free movement of the sign panel when attached to the frame. A sign panel having 2 or more apetures located generally in the top segment of the sign panel and spaced horizontally apart to generally correspond with the spacing between the V shaped formations in the horizontal header at the wire support frame.

2. A sign panel as set forth in claim 1 wherein the sign panel is imprinted with a reflective material.

3. A sign panel as set forth in claim 1 having a reinforcing material secured to the sign panel with adhesive or mechanical fasteners in the area generally located in a corresponding position by the apetures in the sign panel.

4. A sign panel as set forth in claim 2 wherein the sign panel has a small segment across the top of the panel folded over and secured to the body of the sign panel with adhesive or mechanical fasteners so as to reinforce the area where the apetures are located.
